(19) United States
(12) Patent Application Publication
(10) Pub. No.: US 2010/0152015 A1
(43) Pub. Date: Jun. 17, 2010

(54) COMPOSITE MATERIAL AND COMPOSITE COMPONENT, AND METHOD FOR PRODUCING SUCH

(76) Inventors: Dirk Staudenecker, Heubach (DE); Oliver Lott, Attenweiler (DE); Gert Lindemann, Lichtenstein (DE); Matthias Leonhardt, Stuttgart (DE); Alwin Nagel, Esslingen (DE)

Correspondence Address: KENYON & KENYON LLP, ONE BROADWAY, NEW YORK, NY, 10004, US

(21) Appl. No.: 12/442,443

(22) PCT Filed: Oct. 1, 2007
(86) PCT No.: PCT/EP2007/060383

§ 371 Date: Oct. 22, 2009

(30) Foreign Application Priority Data
Oct. 6, 2006 (DE) 2006047394.9

(51) Int. Cl. C04B 38/00; B05D 3/00

(52) U.S. Cl. 501/80; 427/299

(57) ABSTRACT

A composite material, a composite component made thereof, and a method for producing a metal-ceramic composite material or a composite component are provided. The composite material or the composite component is produced by the method described in the following. In a first step, a porous ceramic preform is produced from a ceramic starting mass, and in a second step the infiltration of the porous ceramic preform with a molten metal takes place, the ceramic starting mass having a ceramic main component and a ceramic minor component that reacts with this main component, and the minor component reacts at least partially with the main component during the first and/or second step.

### FIELD OF THE INVENTION

The present invention relates to a composite material, a composite component made thereof, and to a method for producing a metal-ceramic composite or a composite component.

### BACKGROUND INFORMATION

Composite materials and composite components are generally known. German Patent Application No. DE 103 50 035 A1, for example, describes a method for producing a composite component and also a metal-ceramic component. In this case, a metal matrix composite material made of a ceramic preform is infiltrated or filled with molten metal in nonpressurized manner or by applying external pressure, the molten metal having a reactive alloying element, which is converted with a reactive component of the ceramic phase.

Ceramic-metal composite materials may be in the form of what is known as cast metal matrix composites (MMC_{cast}) in which up to 20% ceramic fibers or particles are added during the production of a metal phase to be cast, or else they may also be in the form of a preform-based metal matrix composite material (MMC_{pref}); the latter can have a ceramic content of possibly more than 60% and thus is more resistant to wear and corrosion compared to cast metal matrix composite materials.

A disadvantage of the conventional methods is that the desired reaction between the reactive alloying element and the reactive component of the ceramic phase takes place only incompletely and therefore results in a very inhomogeneous grain structure and an at least locally heavily reduced thermal conductivity, in particular in the case of components having a large volume. Furthermore, porosity can occur in the related art, which has an adverse effect on the strength of the composite component.

### SUMMARY

An example embodiment of the invention may have the advantage that the metal phase or the molten metal, preferably consisting of a material having high thermal conductivity, bonds to the ceramic phase or the preform. The bonding at the boundary surface or the entire boundary-surface chemistry between the preform (ceramic phase) and the metal phase ensures high material strength and an increased thermal conductivity of the composite material or the composite component. According to the example embodiment of the present invention, this is achieved in that the ceramic starting mass of the composite component or the composite material includes a ceramic main component and a ceramic minor constituent. The ceramic minor constituent preferably represents a constituent part of the starting mass of between 0.05 mass % and approximately 30 mass %, preferably between approximately 1 mass % and approximately 3 mass %. During the course of the sintering operation to produce the ceramic preform or during the melt infiltration of the molten metal into the perform, or else both in the course of the sintering process or also the melt infiltration, a reaction takes place between the ceramic main component of the starting mass and the ceramic minor component, in which a surface phase or boundary surface phase is formed as reaction product, which is bound to the main component and thus adheres well. The main component and the minor constituent are selected such in their chemical nature that the surface phase or the boundary surface phase that forms has excellent bonding with the infiltrated metal. An example method according to the present invention is particularly suitable for producing components that are highly stressed with regard to their thermal conductivity under simultaneous high mechanical loading, e.g., by friction and wear. The adaptation of the thermal expansion behavior and the excellent damping characteristics are also advantages that may be utilized with a metal-ceramic composite material according to the present invention. When selecting a metal that has a high melting point, for example, it is possible to use the method to produce brake disks of a motor vehicle, whose maximum service temperature usefully is higher than 700° C. A composite component produced with the aid of the method according to the present invention is characterized by high resistance to wear and corrosion, excellent damage tolerance and high thermal conductivity.

According to an example embodiment of the present invention, it is preferred that the preform has a porosity of between approximately 20 vol. % and approximately 70 vol. %, preferably between approximately 40 vol. % up to approximately 50 vol. %. This makes it possible to achieve especially high strength of the composite component according to the present invention due to a balanced relationship between the preform and the metal phase, as well as excellent bonding between both phases. Furthermore, a high ceramic proportion, i.e., for instance a porosity of the preform of approximately 40 vol. % and approximately 50 vol. %, means high corrosion resistance and high wear resistance.

Furthermore, it is preferred that the preform includes additional components, which are inert with respect to the ceramic main component or with regard to the molten metal, the additional components in particular consisting of particles or fibers formed from an oxide, a carbide, a nitride or a boride. According to an example embodiment of the present invention, high-strength components of the composite component are advantageously able to imbue it with very high strength and temperature resistance. An oxide is, for example, a zirconium dioxide ZrO₂, a carbide is, for example, silicon carbide SiC, a nitride is, for example, a silicon nitride Si₃N₄, boron nitride BN, aluminum nitride AlN, zirconium nitride ZrN or titanium nitride NiN, and a boride is TiB₂, for example. The inert components may be used in particular as reinforcing elements and/or functional elements for the finished composite component. Silicon carbide or aluminum nitride, for example, increases the thermal conductivity of the finished component.

Furthermore, it is preferred that the ceramic minor component includes at least one oxide and/or one carbide and/or one nitride, in particular copper(1)oxide (Cu₂O). In this way, the preform is able to be optimally adapted to the used ceramic main component as reaction partner. If, for example Al₂O₃ is used as ceramic main component and Cu₂O as ceramic minor component, then CuAlO₂ or CuAl₂O₄ forms as boundary surface phase bound to Al₂O₃, which also exhibit excellent bonding to the melt-infiltrated metal, e.g., to pure copper.

In accordance with another example embodiment of the present invention, a composite material and a composite component made of the composite material, in particular a brake disk or a clutch friction element or an axial face seal, has a ceramic, pore-forming phase and a metal phase located within the pores, the composite component having a mechanical strength of more than approximately 500 MPa and a thermal conductivity of more than approximately 100 W/mK, preferably a mechanical strength of more than approximately 600 MPa and a thermal conductivity of more than approximately 120 W/mK. According to the example embodiment of the present invention, it is thereby possible to use the composite component or the material of the present invention to advantage in a multitude of application fields. High thermal conductivity may be of great importance especially for tribologically highly stressed components since high thermal gradients or great thermal stressing or also thermo-mechanical stressing as they may potentially occur due to a high energy input during frictional loading may be avoided or reduced in this manner.

### DETAILED DESCRIPTION OF EXAMPLE EMBODIMENTS

In a first variant of a method according to the present invention, a porous ceramic preform of any desired shape is initially produced in a first method step. The shape of the preform is the typical form of a brake disk, for example, but may take any other shape as well. The preform has a porosity of approximately 20 vol. %, for example, or of approximately 30 vol. % or of approximately 40 vol. % or of approximately 50 vol. % or of approximately 60 vol. % or of approximately 70 vol. %. The range varies between approximately 20 vol. % and approximately 70 vol. %, for instance, preferably between approximately 40 vol. % and approximately 50 vol. %.

According to the example embodiment of the present invention, a metal-ceramic material is produced with the aid of the production method of the present invention, the bonding of a metal phase, which preferably has high thermal conductivity, with a ceramic phase, which preferably has high wear resistance, being induced during the production steps. The metal phase preferably includes pure copper or else some other metal that preferably has high thermal conductivity, essentially in pure form or as an alloy. In order to realize the bonding of the metal phase to the ceramic phase, a minor component is added to the ceramic, i.e., the starting mass. During the sintering process or during the melt infiltration, it reacts with the ceramic main component, so that a boundary surface phase bound to the ceramic main component forms with advantageous bonding to the metal-infiltrated metal phase. According to the present invention, Cu₂O, in particular, is provided as ceramic minor component (of the ceramic phase or the preform). According to the example embodiment of the present invention, this ceramic minor component is present in the ceramic starting mass at a proportion of approximately 0.05 mass % up to approximately 30 mass %, preferably 1 mass % to 3 mass %. The boundary surface phase includes in particular CuAlO₂ or CuAl₂O₄ in case the ceramic main component (the starting mass) is an aluminum oxide, e.g., Al₂0₃.

In one exemplary embodiment of the metal-ceramic material according to the present invention, the ceramic starting mass essentially consisted of Al₂O₃ with an admixture of 2 mass % of Cu₂O. In the course of the sintering process, Cu₂O reacted with Al₂O₃ to the CuAlO₂ phase. The ceramic preform had a porosity of 50 vol. %. The preform was infiltrated by a pure copper melt in what is known as a squeeze cast method. The mechanical strength of the obtained Cu-MMC material or composite component was determined to be 720 MPa. The thermal conductivity was determined to be 143 W/mK. In comparison, an analogous copper-MMC material without the addition of the ceramic minor component, i.e., without Cu₂O in the case at hand, achieved a strength of only 285 MPa and a thermal conductivity of 108 W/mK.

The present invention is not restricted to the above-described exemplary embodiments and, in particular, it is not limited to the manufacture of brake disks. Instead, it may be used for a multitude of ceramic preforms having a shape that is adapted to the particular application case. The ceramic starting mass must have a ceramic minor component which, during the sintering process or during the melt infiltration, reacts with the ceramic main component to a phase that is bound to the ceramic main component. It then also exhibits bonding with respect to the infiltrated metal phase.

1-8. (canceled)

9. A method for producing a composite material or a composite component, comprising:
producing a porous ceramic preform from a ceramic starting mass; and
infiltrating the porous ceramic preform with a molten metal;
wherein the ceramic starting mass includes a ceramic main component and a ceramic minor component, the minor component reacting at least partially with the main component during at least one of the producing and the infiltrating step.

10. The method as recited in claim 9, wherein the ceramic main component is Al₂O₃, and the molten metal is a high-melting metal.

11. The method as recited in claim 10, wherein the molten metal includes one of copper, a copper alloy or pure copper.

12. The method as recited in claim 9, wherein the preform has a porosity of between approximately 20 vol. % and approximately 70 vol. %.

13. The method as recited in claim 12, wherein the porosity is between approximately 30 vol % to approximately 50 vol %.

14. The method as recited in claim 9, wherein the preform includes additional components which are inert with respect to the molten metal and with respect to the ceramic main component, the additional components being made up of particles or fibers, which are formed from one of an oxide, a carbide, a nitride or a boride.

15. The method as recited in claim 9, wherein the ceramic minor component includes at least one of: i) at least one oxide, ii) at least one carbide, and at least one nitride.

16. The method as recited in claim 15, wherein the ceramic minor component includes Cu₂O.

17. The method as recited in claim 9, wherein a proportion of the ceramic minor component in the ceramic starting mass is lies between approximately 0.05 mass % and approximately 30 mass %.

18. The method as recited in claim 17, wherein the proportion is between approximately 1 mass % and approximately 3 mass %.

19. A composite material or composite component, comprising:
a ceramic, pore-forming phase and a metal phase situated within the pores,
wherein the composite material or the composite component has a mechanical strength of more than approximately 500 MPa and a thermal conductivity of more than approximately 100 W/mK.

20. The composite material or composite component as recited in claim 19, wherein the composite component is one of a brake disk, a clutch friction element or an axial face seal.

21. The composite material or composite component as recited in claim 19, wherein the composite material or the composite component has a mechanical strength of more than approximately 600 MPa and a thermal conductivity of more than approximately 120 W/mK.
